(19) United States
(12) Patent Application Publication
(10) Pub. No.: US 2007/0004398 A1
(43) Pub. Date: Jan. 4, 2007

(54) System and method for analyzing reason for network connection failure

(75) Inventor: Teng-Huei Juan, Taiwan (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/246,748

(22) Filed: Oct. 6, 2005

(30) Foreign Application Priority Data
Jun. 29, 2005 (TW) 094121806

(51) Int. Cl. H04Q 7/20

(52) U.S. Cl. 455/423

(57) ABSTRACT

A system and a method for analyzing reason of network connection failure are applied to an electronic information device supporting a wireless network. The system includes an enabling module and a processing module. The enabling module is used for the electronic information device to scan a status of the wireless network, and obtains data of parameter settings when the wireless network is scanned. The processing module is used for analyzing a reason of connection failure between the electronic information device and the wireless network according to the data of parameter settings obtained by the enabling module and parameter data entered by a user, and subsequently informing the user of the reason of the connection failure. Therefore, by means of scanning and analyzing, the present invention allows the user to enter via the electronic information device a plurality of parameter data for connection to the wireless network, and obtain the reason of network connection failure when connection to the wireless network is failed, so as to take prompt and effective measures.

### FIELD OF THE INVENTION

The present invention relates to a system and method for analyzing reason for network connection failure, and more particularly, to a system and method for analyzing reason for network connection failure between an electronic information device and a wireless network.

### BACKGROUND OF THE INVENTION

Wireless Local Area Network (WLAN) realizes network connections and obtains various services from the network without the need for physical media, such as cables. Thus, it is widely employed in various places, such as industries, schools, hotels and scenic spots. In comparison to the current wired network infrastructure, it has the advantages of establishing communications with network systems without the need of communication lines in order to utilize resources provided. Normally, the network coverage of a WLAN depends on the openness of the environment. With no addition of antenna, the coverage is about 250 meters. In semi-opened space with intervals, the coverage is about 35˜30 meters. With the addition of antenna, the effective coverage distance is of course longer. Along with the maturity of network-related technologies and network protocols used, users heavily employ wireless communication network for convenience reasons. In general wireless communication network applications, users only need to insert a wireless network card into an electronic information device with a WLAN interface, such as a personal computer or a hand-held device, the electronic information device then performs site survey, i.e. searches for an access point (e.g. a bridge) or a wireless router capable of wireless network connection and other user ends using the wireless network within the connection range of the installed wireless network card. After connection request and network establishment, various services provided by the wireless network can be used. Additionally, the electronic information device is able to freely move about within the wireless network coverage area while staying connected to the network.

In FIGS. 1A and 1B, an embodiment of the site survey method is schematically shown. In general, there are two types of site survey for a wireless network: one is beaconing and the other is scanning. As shown in FIG. 1A, a wireless network base station 20A sends a broadcast beacon 24 at certain interval to every electronic information device 22A supporting the wireless network within the wireless network service effective area provided by the wireless network base station 20A. The beacon informs the electronic information devices 22A that they are currently within the coverage area of the wireless network base station 20A so as to allow the electronic information devices 22A to connect therewith. After successful connection, the wireless network services provided by the wireless base station 20A can then be used. The beacon 24 is a broadcast signal that is not directed to specific electronic information device 22A and sent periodically (e.g. every 10 milliseconds). The other site survey method is the scanning method as shown in FIG. 1B, where an electronic information device 22B supporting the wireless network actively sends a probe request signal 26 for scanning the presence of a wireless network base station 20B in the proximity (At the same time, other user ends using the wireless network are also scanned as described above, such as electronic information devices 22C shown). If so, connection can be requested to establish connection with the wireless network base station 20B so that wireless network services provided by the wireless network base station 20B can be used. The probe request signal 26 can be omnidirectional that is not directed to a specific wireless network base station 20B. If an electronic information device 22B is present in the wireless network service effective area of a wireless network base station 20B, upon receiving the probe request signal 26, the wireless network base station 20B sends a probe response signal 28 to the electronic information device 22B that sent the probe request signal 26 to inform the electronic information device 22B that it is currently in the coverage area of the wireless network base station 20B. Thereafter, the electronic information device 22B can connect to the wireless network base station 20B and use the wireless network services provided by the wireless network base station 20B after successfully connected thereto.

However, in the wireless network connection technology of the current WLAN, if the electronic information device is unable to establish a wireless network connection with the wireless network base station, the electronic information device will only notify the user with a network connection failure message, but not the reason for such failure. The user is unable to determine whether the problem of wireless network connection failure is due to the electronic information device, the wireless network base station or the wireless network space. Thus, no effective and prompt measures can be taken by the user, which left the user in a helpless situation. Additionally, if the user is not using certified mechanism, after wireless network connection failed, the user may be confused since a connection established message may be returned by the wireless network base station.

Thus, in general, the user has to perform site survey from the beginning and analyze on his/her own any returned signal data to determine the possible reasons behind the wireless network connection failure. However, such manner can only be performed by a user skilled in this art. For a layperson, it would often be a time-consuming and challenging task. Furthermore, this method requires the site survey to be performed from the start, which causes inconveniences for the users. Moreover, the users have to analyze the data by themselves to derive the reason of failure, which is time consuming and mentally demanding. Even if the reason of the wireless network connection failure is determined by the users, it is not always correct due to individual subjectiveness, so the users are still unable to take corresponding measures promptly and effectively to solve the problem of wireless network connection failure.

Thus, a method and system for analyzing reason of network connection failure is required to solve aforementioned problems in the prior art and to provide users with fast and accurate reasons of wireless network connection failure, allowing prompt and effective measures to be taken by the users.

### SUMMARY OF THE INVENTION

In the light of forgoing drawbacks, an objective of the present invention is to provide a system and method for analyzing the reason for network connection failure, so that users can accurately and quickly obtain the reason for wireless network connection failure.

Another objective of the present invention is to provide a system and method for analyzing the reason for network connection failure that allows the users to take corresponding measures promptly and effectively based on the reason for network connection failure.

In accordance with the above and other objectives, the present invention provides a system for analyzing the reason for network connection failure applicable in an electronic information device supporting wireless network, comprising an enabling module that enables the electronic information device to scan a status of the wireless network and obtains data of parameter settings of a wireless network being scanned; and a processing module for analyzing the reason for the network connection failure between the electronic information device and the wireless network according to the data of parameter settings obtained by the enabling module and parameter data inputted by a user and informing the user of the reason for the connection failure.

Corresponding to the system for analyzing reason for network connection failure, the present invention further discloses a method for analyzing the reason for network connection failure applicable in an electronic information device supporting wireless network. The method firstly enables the electronic information device to scan a status of the wireless network and obtains data of parameter settings of the wireless network, and then compares the data of parameter settings with parameter data inputted by the user in order to analyze and obtain the reason for the network connection failure between the electronic information device and the wireless network, and finally informs the user the reason for the network connection failure.

In comparison to the problems exist in the prior art, the present invention allows users to input a plurality of parameter data for connecting with a wireless network via the electronic information device, and after wireless network connection fails, obtains the reason for such connection failure such that corresponding measures can be taken promptly and effectively.

### BRIEF DESCRIPTION OF THE DRAWINGS

The present invention can be more fully understood by reading the following detailed description of the preferred embodiments, with reference made to the accompanying drawings, wherein:

FIGS. 1A and 1B are schematic diagrams showing implementation of site survey;

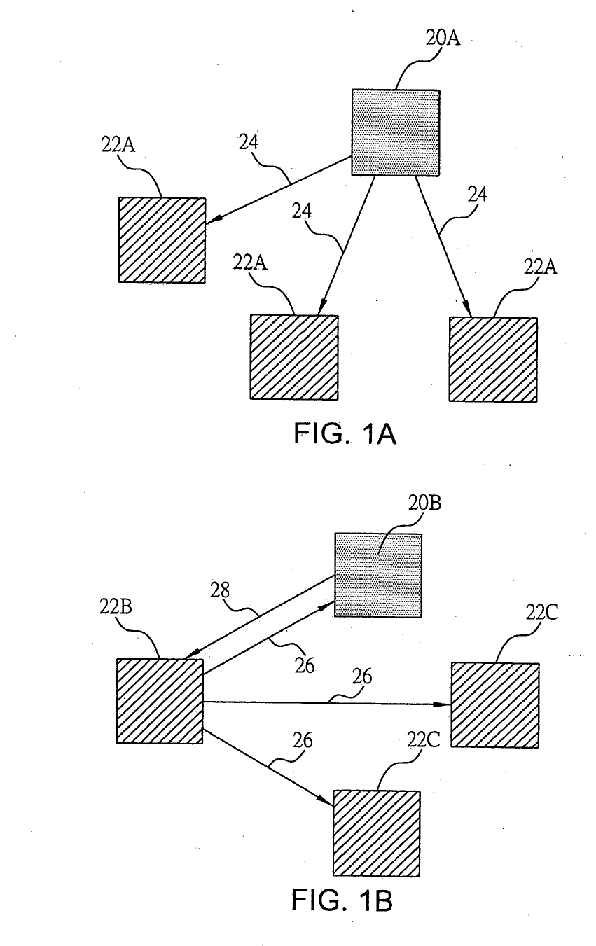

FIG. 2 is a structural block diagram showing the system for analyzing reason for network connection failure of the present invention;

FIG. 3 is an operational flowchart of the method for analyzing reason for network connection failure of the present invention; and

FIG. 4 is a flowchart for implementing steps S12 and S13 of the method for analyzing network connection failure of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

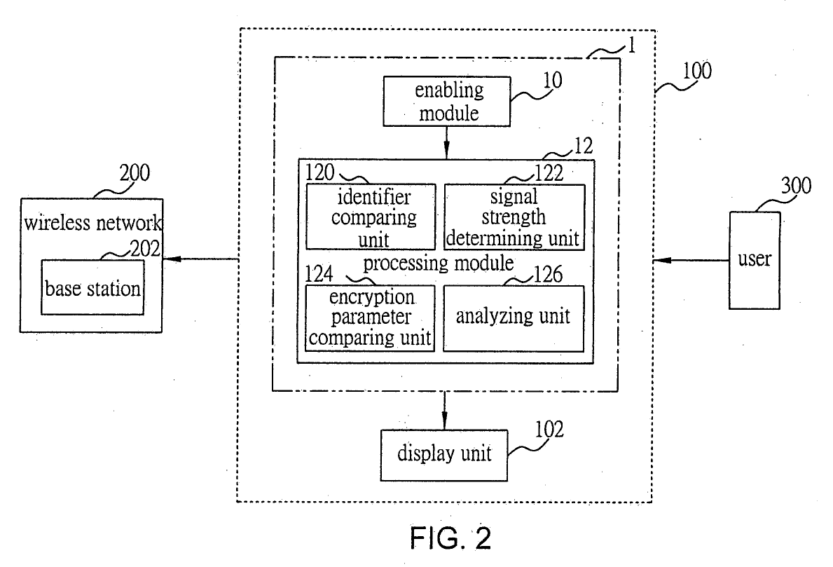

In FIGS. 2, 3, 4 and 5, diagrams relating to the system and method for analyzing reason for network connection failure of the present invention are shown. The preferred embodiments of the system and method for analyzing reason for network connection failure of the present invention are described in conjunction with these diagrams. However, it should be noted that these diagrams are only schematic diagrams illustrating basic structures and process flows of the present invention. Thus, only those elements and texts related to the present invention are shown in the diagrams.

FIG. 2 shows a structural block diagram of the system 1 for analyzing network connection failure of the present invention. The system is applied to an electronic information device 100 (e.g. a palm-top computer, a desktop computer, a notebook computer a personal computer, a supercomputer, a server computer, a Personal Digital Assistant (PDA), a cell phone, and a game devices with external or internal computer processing mechanisms) supporting a wireless network 200. The user 300 can enter a plurality of parameter data for connecting to the wireless network 200 via the electronic information device 100. If connection with the wireless network 200 fails, then the reason for such failure can be obtained for measures to be taken immediately and effectively. The electronic information device 100 is provided with a wireless network card (not shown) and a display unit 102 (e.g. a display monitor and lights etc.). The wireless network is a Wireless Local Area Network (WLAN), including at least one wireless base station 202 used as a connection interface for wireless network 200, such as an Access Point (AP) or a wireless router etc. Moreover, the parameter data includes at least a Service Set Identifier (SSID) and an encryption parameter. The encryption parameter at least includes an encryption type.

The system 1 for analyzing reasons for network connection failure of the present invention can be externally connected to or internal built in the electronic information device 100. This embodiment illustrates the internal built-in manner. The system comprises an enabling module 10 and a processing module 12. The enabling module is used for the electronic information device to scan the status of the wireless network 200, and obtains data of parameter setting thereof when the wireless network is scanned. The processing module is used for analyzing a reason of connection failure between the electronic information device 100 and the wireless network 200 according to the data of parameter settings obtained by the enabling module 10 and parameter data entered by a user 300, and subsequently informing the user 300 of the reason of the connection failure.

The enabling module 10 makes the electronic information device 100 to perform a site survey to scan the status of the wireless network 200 and obtains the data of parameter settings thereof when the wireless network 200 is scanned. The data of parameter settings at least includes a SSID and an encryption parameter. The encryption parameter comprises an encryption type.

The processing module 12 comprises: an identifier comparing unit 120, a signal strength determining unit 122, an encryption parameter comparing unit 124 and an analyzing unit 126.

The identifier comparing unit 120 is used for determining whether an SSID exists in the data of parameter settings obtained by the enabling module 10. If so, the SSID in the data of parameter settings are compared with the SSID in the parameter data and a message of the identifier comparison result is outputted. If not, then a no network message is outputted. The signal strength determining unit 122 determines network connection signal strength of the wireless network according to the data of parameter settings obtained by the enabling module 10, and a message of the signal strength determining result is outputted. The encryption parameter comparing unit 124 compares the encryption parameter in the data of parameter settings obtained by the enabling module 10 and the encryption parameter in the parameter data, and a message of the encryption parameter comparing result in outputted. The analyzing unit 126 is used to receive the message of the identifier comparing result or the no network message, the message of the signal strength determining result and the message of the encryption parameter comparing result, and analyze these messages to determine the reason for connection failure between the electronic information device 100 and the wireless network 200, and inform the user 300 of the reason of connection failure.

The analysis performed by the analyzing unit 126 comprises the steps as follows. The analyzing unit 126 analyzes the identifier comparing result message or the no network message. If the no network message is received, the user 300 is informed that no network service is available via the display unit 102, and no further analysis on the messages of the signal strength determining result and the encryption parameter comparing result. If the message of the identifier comparing result is received, then analysis is performed on the message of the identifier comparing result.

According to the above, the analyzing unit 126 analyzes the message of the identifier comparing result. If the message of the identifier comparing result indicates that the SSID in the data of parameter settings is identical to the SSID in the parameter data, then the analysis of the message of the signal strength determining result is performed. If the message of the identifier comparing result indicates that the SSID in the data of parameter settings is different from the SSID in the parameter data, then the user 300 is informed of entering the wrong SSID via the display unit 102, and the analyses of the messages of the signal strength determining result and the encryption parameter comparing result are not performed.

From the above, the analyzing unit 126 then analyzes the message of the signal strength determining result. If the message of the signal strength determining result indicates that the network connection signal strength is normal, then performs the analysis of the message of the encryption parameter comparing result. If the message of the signal strength determining result indicates that the network connection signal strength is abnormal, then the user 300 is informed via the display unit 102 that the network connection signal of the wireless network is weak and that the analysis of the message of the encryption parameter comparing result is not performed.

From the above, the analyzing unit 126 analyzes the message of the encryption parameter comparing result. If the message of the encryption parameter comparing result indicates that the encryption parameter in the data of parameter settings obtained by the enabling module 10 is identical to the encryption parameter in the parameter data, then the user 300 is informed via the display unit 102 that the reason of network connection failure between the electronic information device 100 and the wireless network is due to incorrect encryption key. If the message of the encryption parameter comparing result indicates that the encryption parameter in the data of parameter settings obtained by the enabling module 10 is not identical to the encryption parameter in the parameter data, then the user 300 is informed that the reason of network connection failure between the electronic information device 100 and the wireless network is due to incorrect encryption parameter.

Thus, the reason of wireless network connection failure can be automatically analyzed and returned to the user by the analyses performed by the system for analyzing reason of network connection failure of the present invention. Thus, the user may accurately and quickly obtain the reason of wireless network connection failure and take corresponding measures, reducing operational complexity and time consumed.

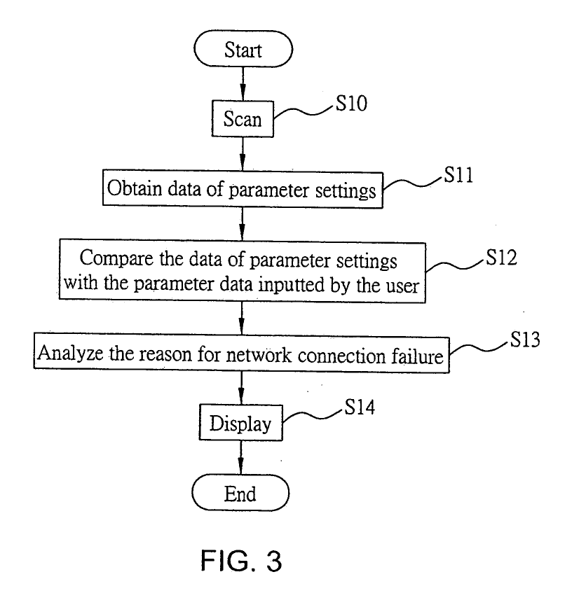

Referring now to FIG. 3, where the operational flow of the method for analyzing reason for network connection failure of the present invention is shown. The method for analyzing reason for network connection failure is applicable to an electronic information device supporting wireless network. The method allows users to input a plurality of parameter data for wireless network connection via the electronic information device, and if the wireless network connection fails, the method determines the reason of such network connection failure so that measures can be taken promptly and effectively. The parameter data includes at least a Service Set Identifier (SSID) and an encryption parameter. The encryption parameter at least includes an encryption type. It should be noted that the embodiments of wireless network, various devices, modules and units mentioned in the method for analyzing reason for network connection failure of the present invention are the same as those disclosed in the system for analyzing reason for network connection failure of the present invention. The method firstly executes step S10.

In step S10, the electronic information device scans the wireless network status. In this step, the user can manually control the electronic information device or via an enabling module to perform a site survey in order to scan the wireless network status. The electronic information device is provided with a wireless network card. Then, perform step S11.

In step S11, the electronic information device obtains data of parameter settings of the wireless network when the wireless network is scanned. The data of parameter settings at least includes a SSID and an encryption parameter. The encryption parameter comprises an encryption type. Then, perform step S12.

In step S12, a processing module compares the data of parameter settings with the parameter data inputted by the user. Then, perform step S13.

In step S13, the processing module determines the reason for connection failure between the electronic information device and the wireless network by analyzing the comparing results. Then, proceed to step S14.

In step S14, the electronic information device notifies the user via a display unit the reason for connection failure with the wireless network.

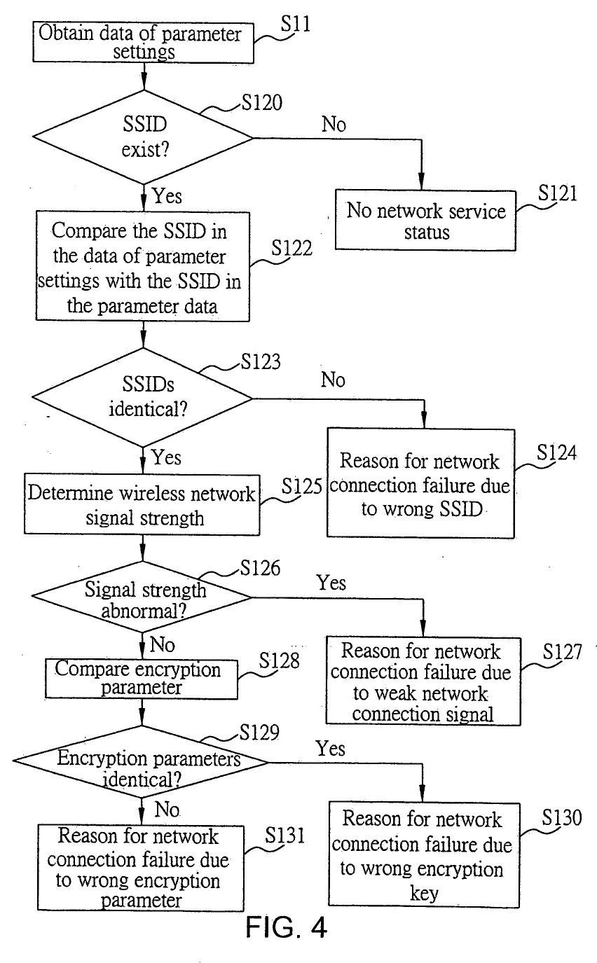

In conjunction with FIG. 4, the flow of the detailed implementations of steps S12 and S13 are explained.

In step S120, determining whether there is a SSID in the obtained data of parameter settings by an identifier comparing unit. If so, then proceed to step S122; else, proceed to step S121.

In step S121, since that no SSID exists in the data of parameter settings, an analyzing unit analyzes a message of no network outputted by the identifier comparing unit and informs the user that he/she is currently in a no network service status.

In step S122, since that a SSID exists in the data of parameter settings, the identifier comparing unit compares the SSID in the data of parameter settings with the SSID in the parameter data, and outputs a message of the identifier comparing result to the analyzing unit. Then, proceed to step S123.

In step S123, the analyzing unit receives and analyzes the message of identifier comparing result. If the message of the identifier comparing result indicates that the SSID in the data of parameter settings is identical to the SSID in the parameter data, then proceed to step S125. If the message of the identifier comparing result indicates that the SSID in the data of parameter settings is different from the SSID in the parameter data, then proceed to step S124, where the user 300 is informed via the display unit 102 that the reason of network connection failure is due to wrong SSID entered.

In step S125, a signal strength determining unit determines the network connection signal strength of the wireless network based on the data of parameter settings obtained, and outputs a message of the signal strength determining result to the analyzing unit. Then, proceed to step S126.

In step S126, since that the message of the identifier comparing result indicates the SSID in the data of parameter settings is identical to the SSID in the parameter data, the analyzing unit analyzes the message of signal strength determining result, and if the signal strength determining result indicates that the network connection signal strength is abnormal, then proceed to step S127, where the user informed that the reason for connection failure between the electronic information device and the wireless network is due to a weak network connection signal of the wireless network. If the signal strength determining result indicates that the network connection signal strength is abnormal, then proceed to step S128.

In step S128, an encryption parameter comparing unit compares the encryption parameter in the data of parameter settings with the encryption parameter in the parameter data, and outputs a message of the encryption parameter comparing result to the analyzing unit. Then, proceed to step S129.

In step S129, since the message of the signal strength determining result indicates the network connection signal strength is normal, then the analyzing unit analyzes the message of the encryption parameter comparing result. If the message of the encryption parameter comparing result indicates that the encryption parameter in the data of parameter settings is identical to the encryption parameter in the parameter data, then proceed to step S130, where the user is informed that the reason of network connection failure between the electronic information device and the wireless network is due to incorrect encryption key. If the message of the encryption parameter comparing result indicates that the encryption parameter in the data of parameter settings is not identical to the encryption parameter in the parameter data, then the user is informed that the reason of network connection failure between the electronic information device and the wireless network is due to incorrect encryption parameter.

It is clear from the above system and method for analyzing reason for network connection failure that the technical features and implementations of the system and method for analyzing reason for network connection failure disclosed in the present invention allows the users to input a plurality of parameter data for connecting with wireless network via the electronic information device, and if the wireless network connection fails, the users may accurately and quickly obtain the reason of wireless network connection failure and take corresponding measures, reducing operational complexity and time consumed.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A system for analyzing reason for network connection failure applicable in an electronic information device supporting a wireless network, allowing a user to input a plurality of parameter data via the electronic information device for connecting with the wireless network, and after the wireless connection fails, allowing the user to obtain the reason for the connection failure so that corresponding measures can be taken promptly and effectively, the system comprising:
an enabling module enabling the electronic information device to scan a status of the wireless network and obtaining data of parameter settings of the wireless network being scanned; and
a processing module for analyzing the reason for the network connection failure between the electronic information device and the wireless network according to the data of parameter settings obtained by the enabling module and the parameter data inputted by the user and informing the user of the reason.

2. The system for analyzing for network connection failure of claim 1, wherein the wireless network is a Wireless Local Area Network (WLAN).

3. The system for analyzing for network connection failure of claim 2, wherein the WLAN comprises at least one wireless base station.

4. The system for analyzing for network connection failure of claim 3, wherein the wireless base station is one of a network bridge-and a wireless router.

5. The system for analyzing for network connection failure of claim 1, wherein the electronic information device is provided with a wireless network card.

6. The system for analyzing for network connection failure of claim 1, wherein the electronic information device comprises at least one display unit, the display unit displays the reason for network connection failure between the electronic information device and the wireless network analyzed by the processing module in order to inform the user.

7. The system for analyzing for network connection failure of claim 6, wherein the display unit is one of a display monitor and a light.

8. The system for analyzing for network connection failure of claim 1, wherein the electronic information device is one selected from the group consisting of a palmtop computer, a desktop computer, a notebook computer a personal computer, a supercomputer, a server computer, a Personal Digital Assistant (PDA), a cell phone, and a game devices with external or internal computer processing mechanisms.

9. The system for analyzing for network connection failure of claim 1, wherein the parameter data comprises a Service Set Identifier (SSID) and an encryption parameter.

10. The system for analyzing for network connection failure of claim 9, wherein the encryption parameter comprises an encryption type.

11. The system for analyzing for network connection failure of claim 1, wherein the enabling module enables the electronic information device to perform site survey to scan the status of the wireless network.

12. The system for analyzing for network connection failure of claim 11, wherein the site survey is used to scan for wireless base station available for connecting with the electronic information device and obtain the data of parameter settings of the scanned wireless base station.

13. The system for analyzing for network connection failure of claim 1, wherein the data of parameter settings comprises a SSID and an encryption parameter.

14. The system for analyzing for network connection failure of claim 13, wherein the encryption parameter comprises an encryption type.

15. The system for analyzing for network connection failure of claim 1, wherein the processing module comprises:
an identifier comparing unit for determining whether a SSID exists in the data of parameter settings obtained by the enabling module, if so, then the SSID in the data of parameter settings is compared with the SSID in the parameter data, and a message of the identifier comparing result is outputted; if not, then a no network message is outputted;
a signal strength determining unit for determining the network connection signal strength of the wireless network according to the data of parameter settings obtained by the enabling module and outputting a message of the signal strength determining result.;
an encryption parameter comparing unit for comparing an encryption parameter in the data of parameter settings obtained by the enabling module with an encryption parameter in the parameter data, and outputting a message of the encryption parameter comparing result; and
an analyzing unit for receiving the messages of the identifier comparing result or the no network, the signal strength determining result and the encryption parameter comparing result, and analyzing these messages to determine the reason for connection failure between the electronic information device and the wireless network and informing the user of the reason.

16. The system for analyzing for network connection failure of claim 15, wherein the analyzing unit first determining whether the message of the identifier comparing result or the no network message is received, and in the case of receiving the no network message, the user is informed of a no network service status and the analyses of the messages of the signal strength determining result and the encryption parameter comparing result are not performed.

17. The system for analyzing for network connection failure of claim 15, wherein the analyzing unit first determining whether the message of the identifier comparing result or the no network message is received, and in the case of receiving the message of the identifier comparing result, then analyzing the message of the identifier comparing result, and if the message of the identifier comparing result indicates that the SSID in the data of parameter settings is identical to the SSID in the parameter data, then analysis on the message of the signal strength determining result is performed; else if the message of the identifier comparing result indicates that the SSID in the data of parameter settings is different from the SSID in the parameter data, then the user is informed that a wrong SSID is inputted and analyses on the messages of the signal strength determining result and the encryption parameter comparing result are not performed.

18. The system for analyzing for network connection failure of claim 17, wherein when the analyzing unit is analyzing the message of the signal strength determining result, if the message of the signal strength determining result indicates that the network connection signal strength is normal, then the analysis on the message of the encryption parameter comparing result is performed; else if the message of the signal strength determining result indicates that the network connection signal strength is abnormal, then the user is informed that the network connection signal of the wireless network is weak and the analysis on the message of the encryption parameter comparing result is not performed.

19. The system for analyzing for network connection failure of claim 18, wherein when the analyzing unit is analyzing the message of the encryption parameter comparing result, if the message of the encryption parameter comparing result indicates that the encryption parameter in the data of parameter settings is identical to the encryption parameter in the parameter data, then the user is informed that the reason of connection failure between the electronic information device and the wireless network is due to wrong encryption key inputted; else if the message of the encryption parameter comparing result indicates that the encryption parameter in the data of parameter settings is different from the encryption parameter in the parameter data, then the user is informed that the reason of connection failure between the electronic information device and the wireless network is due to wrong encryption parameter inputted.

20. The system for analyzing for network connection failure of claim 19, wherein the encryption parameter comprises an encryption type.

21. A method for analyzing reason for network connection failure applicable in an electronic information device supporting a wireless network, allowing a user to input a plurality of parameter data via the electronic information device for connecting with the wireless network, and after the wireless connection fails, allowing the user to obtain the reason for the connection failure so that corresponding measures can be taken promptly and effectively, the method comprising the following steps:
enabling the electronic information device to scan a status of the wireless network and obtaining data of parameter settings of the wireless network being scanned;
comparing the data of parameter settings with parameter data inputted by the user and analyzing to obtain the reason for the network connection failure between the electronic information device and the wireless network; and
informing the user of the reason for the network connection failure.

22. The method for analyzing for network connection failure of claim 21, wherein the wireless network is a Wireless Local Area Network (WLAN).

23. The method for analyzing for network connection failure of claim 22, wherein the WLAN comprises at least one wireless base station.

24. The method for analyzing for network connection failure of claim 23, wherein the wireless base station is one of a network bridge and a wireless router.

25. The method for analyzing for network connection failure of claim 21, wherein the electronic information device is provided with a wireless network card.

26. The method for analyzing for network connection failure of claim 21, wherein the electronic information device comprises at least one display unit, the display unit displays the reason for network connection failure between the electronic information device and the wireless network analyzed by the processing module in order to inform the user.

27. The method for analyzing for network connection failure of claim 26, wherein the display unit is one of a display monitor and a light.

28. The method for analyzing for network connection failure of claim 21, wherein the electronic information device is one selected from the group consisting of a palmtop computer, a desktop computer, a notebook computer a personal computer, a supercomputer, a server computer, a Personal Digital Assistant (PDA), a cell phone, and a game devices with external or internal computer processing mechanisms.

29. The method for analyzing for network connection failure of claim 21, wherein the parameter data comprises a Service Set Identifier (SSID) and an encryption parameter.

30. The method for analyzing for network connection failure of claim 29, wherein the encryption parameter comprises an encryption type.

31. The method for analyzing for network connection failure of claim 21, wherein the enabling of electronic information device to scan the status of the wireless network is achieved by an enabling module.

32. The method for analyzing for network connection failure of claim 31, wherein the enabling module enables the electronic information device to perform site survey in order to scan the status of the wireless network.

33. The method for analyzing for network connection failure of claim 32, wherein the site survey is used to scan for wireless base station available for connecting with the electronic information device and obtain the data of parameter settings of the scanned wireless base station.

34. The method for analyzing for network connection failure of claim 21, wherein the data of parameter settings comprises a SSID and an encryption parameter.

35. The method for analyzing for network connection failure of claim 34, wherein the encryption parameter comprises an encryption type.

36. The method for analyzing for network connection failure of claim 33, wherein the comparing of the data of parameter settings and the parameter data inputted by the user and the analysis for the reason for network connection failure between the electronic information device and the wireless network are achieved by a processing module.

37. The method for analyzing for network connection failure of claim 36, wherein the processing module comprises:
an identifier comparing unit for determining whether a SSID exists in the data of parameter settings obtained by the enabling module, if so, then the SSID in the data of parameter settings is compared with the SSID in the parameter data, and a message of the identifier comparing result is outputted; if not, then a no network message is outputted;
a signal strength determining unit for determining the network connection signal strength of the wireless network according to the data of parameter settings obtained by the enabling module and outputting a message of the signal strength determining result.;
an encryption parameter comparing unit for comparing an encryption parameter in the data of parameter settings obtained by the enabling module with an encryption parameter in the parameter data, and outputting a message of the encryption parameter comparing result; and
an analyzing unit for receiving the messages of the identifier comparing result or the no network, the signal strength determining result and the encryption parameter comparing result, and analyzing these messages to determine the reason for connection failure between the electronic information device and the wireless network and informing the user of the reason.

38. The method for analyzing for network connection failure of claim 37, wherein the analyzing unit first determining whether the message of the identifier comparing result or the no network message is received, and in the case of receiving the no network message, the user is informed of a no network service status and the analyses of the messages of the signal strength determining result and the encryption parameter comparing result are not performed.

39. The method for analyzing for network connection failure of claim 37, wherein the analyzing unit first determining whether the message of the identifier comparing result or the no network message is received, and in the case of receiving the message of the identifier comparing result, then analyzing the message of the identifier comparing result, and if the message of the identifier comparing result indicates that the SSID in the data of parameter settings is identical to the SSID in the parameter data, then analysis on the message of the signal strength determining result is performed; else if the message of the identifier comparing result indicates that the SSID in the data of parameter settings is different from the SSID in the parameter data, then the user is informed that a wrong SSID is inputted and analyses on the messages of the signal strength determining result and the encryption parameter comparing result are not performed.

40. The method for analyzing for network connection failure of claim 39, wherein when the analyzing unit is analyzing the message of the signal strength determining result, if the message of the signal strength determining result indicates that the network connection signal strength is normal, then the analysis on the message of the encryption parameter comparing result is performed; else if the message of the signal strength determining result indicates that the network connection signal strength is abnormal, then the user is informed that the network connection signal of the wireless network is weak and the analysis on the message of the encryption parameter comparing result is not performed.

41. The method for analyzing for network connection failure of claim 40, wherein when the analyzing unit is analyzing the message of the encryption parameter comparing result, if the message of the encryption parameter comparing result indicates that the encryption parameter in the data of parameter settings is identical to the encryption parameter in the parameter data, then the user is informed that the reason of connection failure between the electronic information device and the wireless network is due to wrong encryption key inputted; else if the message of the encryption parameter comparing result indicates that the encryption parameter in the data of parameter settings is different from the encryption parameter in the parameter data, then the user is informed that the reason of connection failure between the electronic information device and the wireless network is due to wrong encryption parameter inputted.

42. The system for analyzing for network connection failure of claim 41, wherein the encryption parameter comprises an encryption type.
